(19) United States
(12) Patent Application Publication
(10) Pub. No.: US 2003/0003962 A1
(43) Pub. Date: Jan. 2, 2003

(54) Automatic sliding machanism for portable electronic product, particularly for a sliding front cover of a mobile phone

(76) Inventors: Tan Vooi-Kia, Tokyo (JP); Tang Lung Yee, Singapore (SG); Nir Karasikov, Haifa (IL); Ze?apos;ev Ganor, Meir Herzlia (IL); Alon Avital, Haifa (IL); Hovav Elhayani, Yokneam Illit (IL)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,708

(22) Filed: Jun. 29, 2001

(51) Int. Cl. H04B 1/38

(52) U.S. Cl. 455/566; 455/575; 455/90

(57) ABSTRACT

An automatic sliding mechanism for a portable electronic product, particularly a mobile phone handset, is disclosed. The mechanism moves a cover relative to a body of the handset using a piezoelectric actuator which drivingly engages an elongated connecting member fixed on the cover to directly drive the cover. Advantages of weight and volume reduction, permitting miniaturization, and also lower noise are attained, as compared with the use of a conventional sliding mechanism employing DC motor with gear-train-like lead screw, bevel gear and clutch system. Construction is relatively simple and high positioning accuracy is possible with the improved mechanism. A counter-bearing arrangement on the body counter-balances a pushing force from the piezoelectric actuator on the connecting member. Stoppers at the respective ends of the connecting member engage limit switches provided on the body to limit the sliding movement of the cover on the body.

### TECHNICAL FIELD

The present invention is directed to a motorized sliding mechanism for sliding a cover of a portable electronic product, particularly for sliding a cover of a mobile phone between respective positions of use on the phone.

### BACKGROUND

It is desirable in many instances to provide a movable cover on a portable electronic product such as a mobile telephone to allow the user to move the cover between opened and closed positions, for example. U.S. Pat. Nos. DES.411,205 and DES.412,710 disclose examples of telephone handsets with movable front covers. A manual sliding mechanism and a spring loaded sliding mechanism are utilized in these telephone handsets to permit sliding of the front cover between opened and closed positions. U.S. Pat. No. 6,215,993 B1discloses a mobile phone with a movable cover which allows the user to preview caller ID information on a display that is normally concealed by the cover. The cover can be a flip-type cover, a sliding cover or other type of movable cover.

A motorized sliding mechanism provides a motorized sliding motion to allow the front cover for a telephone handset to slide open and close automatically in response to activation of an open/close button. A conventional motorized sliding mechanism employs a DC motor with a gear-train-like lead screw, a bevel gear and a clutch system. This conventional mechanism is disadvantageous in that it requires considerable volume and has considerable weight. It also generates magnetic and mechanical noises and necessitates the fabrication and assembly of microprecision parts for its use. There is a need for an improved automatic sliding mechanism and a portable electronic product, particularly a mobile phone, employing the same which reduce or eliminate these disadvantages.

The use of resonant piezoelectric ceramics to provide linear and rotational motion is known, per se. For example, U.S. Pat. Nos. 5,616,980; 5,877,579 and 6,064,140 disclose ceramic motors, particularly for use in an X-Y table or a CD reader. U.S. Pat. No. 5,640,063 is directed to a window raising device which utilizes a plurality of piezoelectric motor units operating directly on an element, particularly a car window, to be vertically translated. U.S. Pat. Nos. 6,244,076 and 6,247,338 relate to knitting machines which employ vibratory piezoelectric motors which are friction coupled to components of the knitting machines, namely selector feet and latch needles. Ceramic motors have also been used to move and position a read/write head, e.g., a disc drive. See for example U.S. Pat. Nos. 5,453,653; 5,682,076; 5,714,833 and 5,777,423.

### SUMMARY

An improved automatic sliding mechanism according to the present invention is useful for sliding a movable cover with respect to a body on which the cover is slidingly arranged. In an example embodiment, the invention is utilized in a portable electronic product, particularly a mobile phone handset wherein a movable cover is arranged on the mobile phone for sliding movement with respect to a body of the phone. According to the invention, a piezoelectric actuator is connected to the body and drivingly engages the cover for linearly moving the cover with respect to the body. The cover includes an elongated connecting member fixed on the cover. An output member/surface of the piezoelectric actuator engages the elongated connecting member for directly driving the cover. The invention permits a volume reduction, e.g., miniaturization, and also a weight reduction in comparison with a conventional DC motor with gear-train-like lead screw, bevel gear and clutch system. The present invention is further advantageous in providing a large torque, no magnetic noise, low mechanical noise and a quick response with high positioning accuracy. Fabrication and assembly are also simplified in comparison with the conventional motorized sliding mechanism.

These and other advantages and features of the present invention will become more apparent from the following detailed description taken in connection with the accompanying drawings which show, for purposes of illustration only, one example embodiment in accordance with the present invention.

### BRIEF DESCRIPTION OF DRAWINGS

FIG. 1(A) is a perspective view from the one end, to the right and slightly raised, of a mobile phone of the invention with the front cover in fully opened position.

FIG. 1(B) is a view similar to FIG. 1(A) with the front cover of the mobile phone in partially opened position.

FIG. 1(C) is a view similar to FIG. 1(A) with the front cover in fully closed position.

FIG. 2 is a schematic drawing of the motorized sliding mechanism of the invention for sliding the front cover of the mobile phone with the mechanism shown in a position where the front cover is fully opened.

FIG. 3 is a schematic drawing of the motorized sliding mechanism of the invention with the mechanism shown in a position where the front cover is fully closed.

FIG. 4(A) is a perspective view from one side and above the telephone handset of the mobile phone of the invention showing the construction of the sliding mechanism of FIGS. 2 and 3 in the telephone handset.

FIG. 4(B) is an enlarged view of a portion, denoted by arrow IV(B) in FIG. 4(A), of the construction of the sliding mechanism in the telephone handset of the invention.

FIG. 5 is a perspective view of the back of the front cover of the mobile phone of the example embodiment with the front cover in the fully opened position.

### DETAILED DESCRIPTION

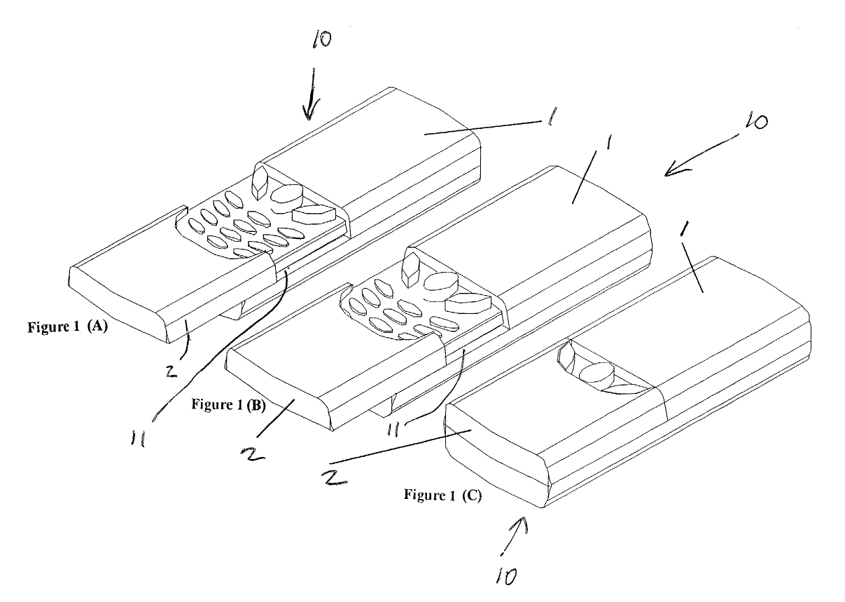

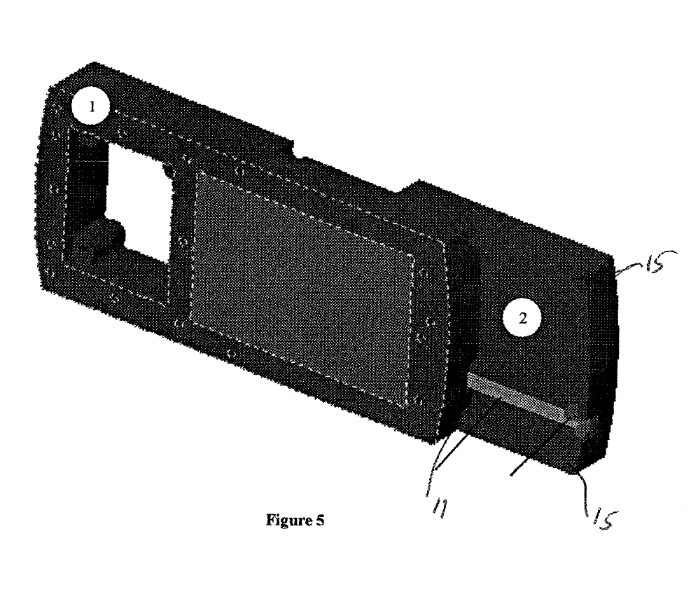

Referring now to the drawings, the example embodiment of the present invention is a mobile phone, especially a telephone handset 10 comprising a main body 1 and a front cover 2 slidably arranged on the body 1 for movement between a fully open position, FIG. 1(A), and a fully closed position, FIG. 1(C). The two sides of the main body are each formed with an elongated groove 11 within which longitudinally extending, inwardly directly flanges 15 on respective sides of the front cover 2 are received. In effect, the main body 1 is telescoped within the front cover 2 in linear, sliding relationship for movement between the respective positions shown in FIGS. 1(A), 1(B) and 1(C). See also FIG. 5 which is a back view of the front cover 2 while the front cover is in the opened position with respect to the main body 1.

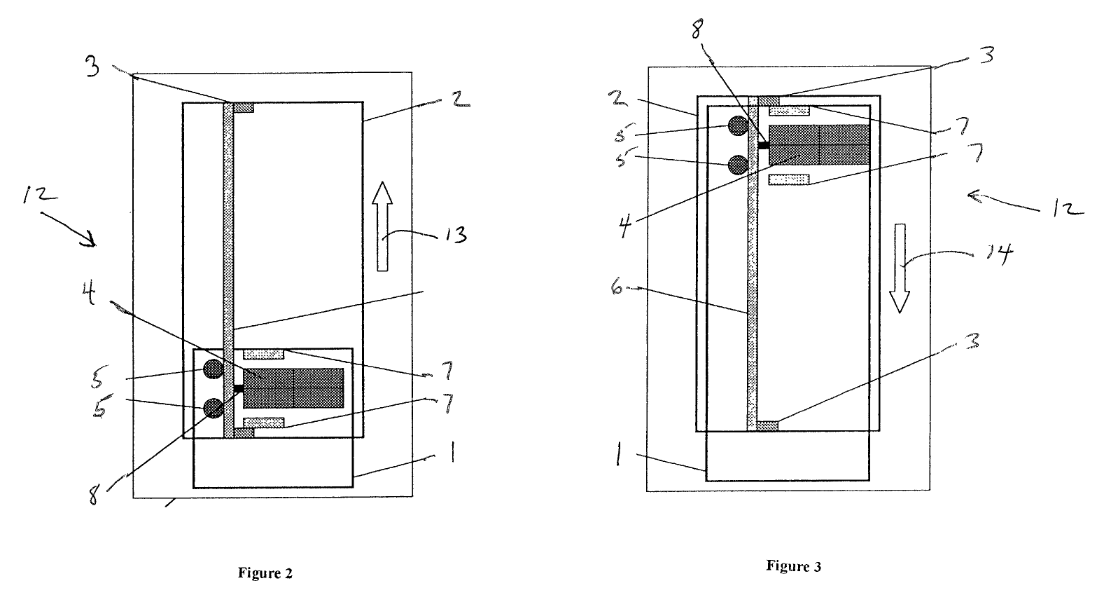

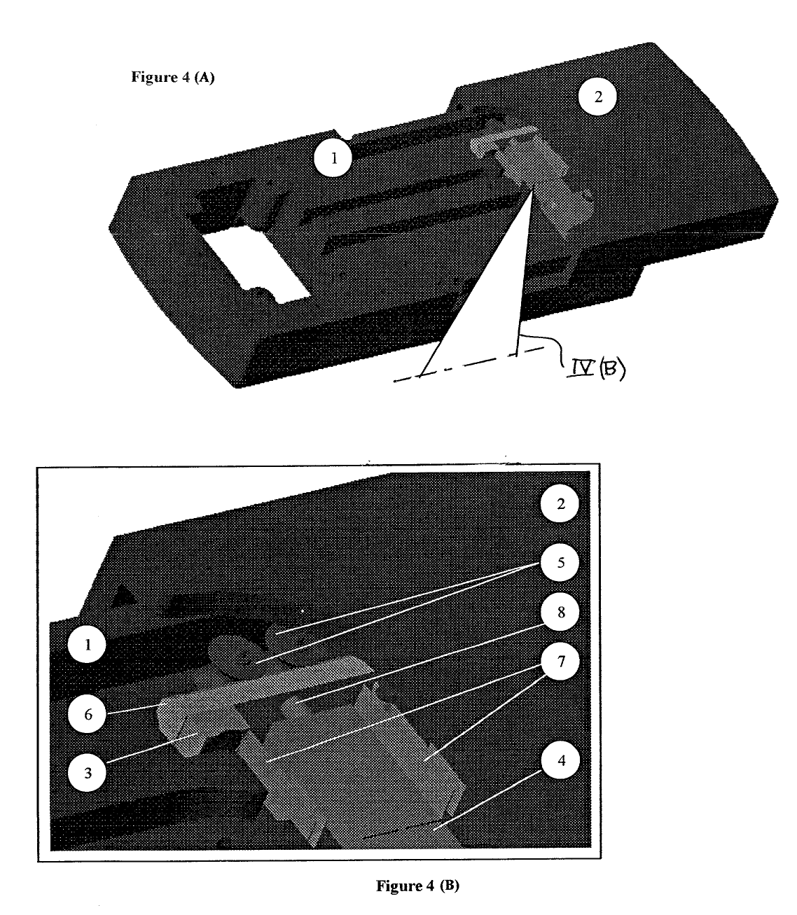

The automatic sliding mechanism 12 of the example embodiment is seen in FIGS. 2-5. The mechanism 12 comprises an elongated connecting member in the form of a connecting rod 6 fixed on the underside of the front cover 2. Mechanism 12 further comprises a piezoelectric actuator 4 connected to the body 1 and drivingly engaging the cover by way of the connecting rod 6 thereon for moving the cover with respect to the body. In the example embodiment, an output member in the form of a finger tip 8 of the actuator 4 engages the elongated connecting member 6 of the cover for directly driving the cover. When the actuator is excited, the finger tip 8 pushes the connecting rod 6 linearly along the connecting rod direction. The direction of movement of the cover to the fully open position is shown by arrow 13 in FIG. 2. Arrow 14 depicts the direction of movement of the front cover to reach the fully closed position shown in FIG. 3. Two rollers 5 are mounted on the body 1 opposite to the actuator to form a counter-bearing arrangement located in engagement with a side of the connecting member opposite the side engaged by the actuator to counter-balance a pushing force from the piezoelectric actuator on the connecting member.

Limit switches 7 are installed at appropriate positions on the body 1 to sense the opened and closed positions of the front cover. Stoppers 3 at respective ends of the connecting rod trigger the limit switches during travel of the front cover in the respective directions. An open/closed button, which could be one of the buttons exposed in the closed position of the front cover as shown in FIG. 1(C) is pressed to activate the piezoelectric actuator 4 to trigger the front cover to open or close automatically.

The operation of the piezoelectric actuator 4 in the automatic sliding mechanism and mobile phone of the invention takes advantage of the piezoelectric effect in piezo ceramics which converts the applied electrical field to mechanical strain. Under special electrical excitation, drive and ceramic geometry of the piezoelectric actuator/motor 4, longitudinal extension and transverse bending oscillation modes are excited at close frequency proximity. The simultaneous excitation of the longitudinal extension mode and the transverse bending mode creates a small elliptical trajectory of the ceramic edge or finger tip 8, thus achieving the dual mode standing wave motor.

By coupling the ceramic edge or finger tip 8 of the piezoelectric actuator 4 to the connecting member fixed on the front cover 2, a resultant driving force is exerted on the front cover, causing its linear movement relative to the main body in conjunction with its sliding engagement with the body as described above. The periodic nature of the driving force at frequencies much higher than the mechanical resonance of the front cover and mobile phone assembly allows continuous smooth motion, while maintaining high resolution and positioning accuracy. Travel is linear in the example embodiment but could be rotary, depending on the coupling mechanism.

The automatic sliding mechanism and portable electronic product employing the same as disclosed herein allow a substantial volume reduction, miniaturization and also weight reduction of the product in comparison with a product employing the conventional DC motor with gear-train-like lead screw, bevel gear and clutch system. Fabrication and assembly of microprecision parts is also eliminated with the present invention. Other advantages of the invention include a large torque, no magnetic noise, low mechanical noise, a large holding torque and a quick response and high positioning accuracy.

While we have shown and described only one example embodiment in accordance with the present invention, it is understood that the same is not limited thereto, but is susceptible to numerous changes and modifications as known to those skilled in the art. For example, the automatic sliding mechanism of the invention could be employed in portable electronic products other than a mobile phone as disclosed herein. The movement of the sliding mechanism could also be rotary rather than linear as disclosed herein. Therefore, we do not wish to be limited to the details shown and described herein, but intend to cover all such changes and modifications as are encompassed by the scope of the appended claims.

We claim:

1. A mobile phone comprising:
a body;
a movable cover arranged on the mobile phone for movement with respect to the body; and
a piezoelectric actuator connected to the body and drivingly engaging the cover for moving the cover with respect to the body.

2. The mobile phone according to claim 1, wherein the mobile phone is a telephone handset.

3. The mobile phone according to claim 1, wherein the cover includes an elongated connecting member fixed on the cover, an output of the piezoelectric actuator engaging the elongated connecting member for directly driving the cover.

4. The mobile phone according to claim 3, wherein the output of the piezoelectric actuator is a finger tip of the actuator.

5. The mobile phone according to claim 3, wherein the output of the piezoelectric actuator drivingly engages the elongated connecting member on a first side of the connecting member, and wherein a counter-bearing arrangement is located on the body in engagement with a second side of the connecting member opposite the first side to counter-balance a pushing force from the piezoelectric actuator on the connecting member.

6. The mobile phone according to claim 5, wherein the counter-bearing arrangement comprises first and second rollers spaced from one another along the length of the connecting member and engaging the second side thereof.

7. The mobile phone according to claim 3, wherein the elongated connecting member is a connecting rod.

8. The mobile phone according to claim 3, further comprising first and second stoppers provided at respective ends of the elongated connecting member for engaging respective limit switches provided on the body to limit the movement of the cover on the body.

9. The mobile phone according to claim 1, wherein the cover is in sliding engagement with the body.

10. The mobile phone according to claim 9, wherein the piezoelectric actuator slides the cover linearly with regard to the body.

11. A portable electronic product comprising:
a body;
a movable cover arranged on the portable electronic product for movement with respect to the body; and
a piezoelectric actuator connected to the body and drivingly engaging the cover for moving the cover with respect to the body.

12. The portable electronic product according to claim 11, wherein the cover includes an elongated connecting member fixed on the cover, an output of the piezoelectric actuator engaging the elongated connecting member for directly driving the cover.

13. The portable electronic product according to claim 12, wherein the output of the piezoelectric actuator is a finger tip of the actuator.

14. The portable electronic product according to claim 12, wherein the output of the piezoelectric actuator drivingly engages the elongated connecting member on a first side of the connecting member, and wherein a counter-bearing arrangement is located on the body in engagement with a second side of the connecting member opposite the first side to counter-balance a pushing force from the piezoelectric actuator on the connecting member.

15. The portable electronic product according to claim 14, wherein the counter-bearing arrangement comprises first and second rollers spaced from one another along the length of the connecting member and engaging the second side thereof.

16. The portable electronic product according to claim 12, wherein the elongated connecting member is a connecting rod.

17. The portable electronic product according to claim 12, wherein first and second stoppers are provided at respective ends of the elongated connecting member for engaging respective limit switches provided on the body to limit the movement of the cover on the body.

18. The portable electronic product according to claim 11, wherein the cover is in sliding engagement with the body.

19. The portable electronic product according to claim 18, wherein the piezoelectric actuator slides the cover linearly with respect to the body.

20. An automatic sliding mechanism comprising:
a movable first member;
a second member on which the movable first member is slidingly arranged;
an elongated connecting member fixed on the first member;
a piezoelectric actuator connected to the second member, an output of the piezoelectric actuator drivingly engaging the elongated connecting member for directly driving the first member to slide the first member with respect to the second member.

21. The automatic sliding mechanism according to claim 20, further comprising a counter-bearing arrangement on the second member adjacent the connecting member to counter-balance a pushing force from the piezoelectric actuator on the connecting member.

22. The automatic sliding mechanism according to claim 21, wherein the counter-bearing arrangement comprises first and second rollers spaced from one another along the length of the connecting member on a side thereof opposite a side thereof drivingly engaged by the output of the piezoelectric actuator.

23. The automatic sliding mechanism according to claim 20, wherein the elongated connecting member is a connecting rod.

24. The automatic sliding mechanism according to claim 20, further comprising first and second stoppers provided at respective ends of the elongated connecting member to engage respective limit switches provided on the second member to limit the sliding movement of the first member on the second member.

25. The automatic sliding mechanism according to claim 20, wherein the first and second members are components of a portable electronic component.

26. The automatic sliding mechanism according to claim 25, wherein the first and second members are a front cover and a body of a mobile phone.

27. The automatic sliding mechanism according to claim 26, wherein the piezoelectric actuator slides the front cover linearly with respect to the body of the mobile phone.
